(19) United States
(12) Patent Application Publication
(10) Pub. No.: US 2009/0084641 A1
(43) Pub. Date: Apr. 2, 2009

(54) WHEEL CYLINDER INTEGRAL AUTO ADJUSTER

(75) Inventors: Malaiappan Viswanathan, Chennai (IN); Thiruvananthaperumal Dharmar, Chennai (IN); R. Srinivasa Rao, Chennai (IN); Tvr Anirudh, Chennai (IN)

Correspondence Address: SHOWATECH INC;SUBSIDIARY OF BRAKES INDIA LIMITE, SUITE 210, NORTH BROOK, #3000, DUNDEE ROAD, ILLINOIS, IL, 60062, US

(73) Assignee: BRAKES INDIA LIMITED, CHENNAI (IN)

(21) Appl. No.: 12/106,445

(22) Filed: Apr. 21, 2008

(30) Foreign Application Priority Data
Apr. 21, 2007 (IN) 576/CHE/2007

(51) Int. Cl. F16D 65/56

(52) U.S. Cl. 188/196 D

(57) ABSTRACT

Wheel cylinder based auto adjuster incorporated within the wheel cylinder housing, comprising a (13) housing, (12) lip seal, (10) plunger, (4) adjuster, (6) adjusting screws, (3) dust cover, (2) a cam screw, (9) copper washer, (8) thrust bearing and (7) excluder assembly characterized in that the said adjusting screw and adjuster being connected by means of (15) threaded joint roller.

### FIELD OF INVENTION

This invention in general relates to the scientific field of mechanical engineering and relates to an automobile brake system. More particularly this invention relates to a wheel cylinder based auto adjuster incorporated within the wheel cylinder housing of a drum brake system.

### BACKGROUND OF INVENTION

As the friction material in a drum brake wears off due to repeated brake applications, the brakes must be constantly readjusted to the set diameter; otherwise, the pedal travel will increase, giving an unsafe feeling for the driver. Conventionally, in a drum brake without auto adjuster, the brakes are manually inspected at regular periodic intervals and are manually adjusted. This type of manual adjustment of brakes involves time and hence money. If there were an automatic adjustment feature in a drum brake, which would sense the wear of the friction material and compensate for the wear without having to externally meddle with the brakes, such a feature would reduce down time and hence save a lot of money. Moreover, if this feature would provide a compensation (or adjustment) in such a way that it would maintain constant clearance between the drum and the shoe at all times, the pedal travel will fall within a narrow band, which is a desirable feature.

In small size brakes that are normally fitted in cars and SUVs, it is known in the art that there are a wide range of automatic adjusters that compensate for the wear of the friction material. Most of these are based on converting the excess rotary travel of the lined shoe assembly (due to lining wear) to linear length increase of an adjustment screw that provides for the wear of the friction material. Whereas such an arrangement might work in a conventional car brake system, in commercial brakes (for brake sizes in excess of 300 mm), mounting of such an adjustment system poses installation difficulties. Secondly, these commercial vehicles are used for an assortment of purposes, including and not limited to sand transport, water transport, etc. Typically, the drivers and the owners of these commercial vehicles are not well informed about maintenance of vehicle in general and brakes in particular. They normally submerge the vehicle upto its cab bottom in water to clean the under body of the vehicle. This means that there is every likelihood that water and slush might enter the brake system and cause havoc in its functionality.

U.S. Pat. No. 4,353,439 claims a drum brake assembly that includes a wheel cylinder and extendible assembly disposed between adjoining ends of a pair of brake shoes. The wheel cylinder includes a pair of pistons which are in abutting relation with each other and with the extendible assembly to substantially define a non-braking position for the pair of brake shoes. The extendible assembly is operable to move the pair of pistons within the wheel cylinder in response to an excessive clearance between the pair of brake shoes and a rotating drum.

U.S. Pat. No. 5,246,091 discloses a wheel cylinder that has a body, pistons, boots and seals. A screw assembly positioned between the two pistons holds the pistons apart to maintain the specified clearance between the brake linings and the brake drum while the brake is released. If a predetermined amount of outward movement of the pistons occurs during brake actuation, the screw rotates with further piston outward movement. When the brake is released, the pistons return inwardly, and the screw is locked against reverse rotation by means of a clutch, preventing the pistons from returning more than the prior predetermined amount of outward movement before screw rotation began. A clutch seal on an extension of one clutch member seals in a piston cylinder section. The other clutch member is formed on that piston next to one end of the cylinder section. The cylinder section axially beyond the seal is vented to atmosphere. A cross pin extends across a cavity in the one clutch member, is mounted in slots formed in the one clutch member and in the screw, and permits limited movements of the pin axially of the wheel cylinder. The space between the closed sides of the one clutch member slots, combined in series with the space between the closed slides of the screw slot, define the allowable amount of axial movement between the two pistons without disengaging the adjuster clutch under excessively high pressure conditions. This allowable amount of axial movement is greater than that occurring in any one cycle of the brake.

US Patent Application 20030066721 discloses a brake shoe adjuster. In a preferred embodiment, the invention discloses floating adjusters with a single adjusting rod. One specifically disclosed embodiment shows an hydraulic adjuster with an adjusting rod, forming a plunger or piston, in an hydraulic cylinder, and driven by grease forced into the cylinder by a grease gun through a zerk grease fitting. Another specifically disclosed embodiment shows a mechanical adjuster with a rod, forming a rack, driven by a pinion gear.

Therefore, it is desirable that we have an automatic adjustment feature that is concealed and protected from these operating parameters. In hitherto available commercial vehicle brakes, no automatic adjustment feature is available in India. After a survey of commercial vehicle drum brakes worldwide, except for Akebono, no other manufacturer has introduced an automatic adjustment feature for their drum brakes. Even in the Akebono design, the automatic adjuster is not concealed and that design, if implemented, would be subject to the same external parameters as the current car drum brake auto adjusters.

### OBJECTIVES

In light of the above scenario, an automatic adjuster for commercial vehicle brakes with the following features is the order of the day.

Accordingly, it is an objective of the present invention to provide for an automatic wear adjustment feature for a commercial vehicle brake that compensates for the wear of the friction material, without any manual external intervention.

Another objective of the present invention is to provide a concealment for this automatic wear adjustment feature so that they are not exposed to water and slush in which these brakes sometimes operate.

A further objective of the present invention is to contain a manual adjustment feature that can be used at will to override the automatic adjustment feature. This feature would help easily dismount the brake in case of a jam.

### SUMMARY OF THE INVENTION

The above referred features are incorporated in the present invention. The entire automatic adjuster mechanism is housed inside the wheel cylinder, without disturbing the normal wheel cylinder function. Two variations of the same concept have been developed. Since the entire mechanism is housed inside the wheel cylinder, there is no possibility of this mechanism coming in contact with water and slush. The mechanism also contains a manual override feature, which can be used to retract the adjuster to the original position.

The following are the advantages of wheel cylinder based auto adjuster:
This concept is very simple and can be packaged inside an existing wheel cylinder housing.
It is incremental in terms of adjustment and hence fine adjustment is possible.
The adjuster makes it very amenable for individual shoe adjustment.

### DESCRIPTION OF DRAWINGS

The advantages and features of the present invention will readily be appreciated by persons skilled in the art from the following detailed description when read in conjunction with the drawings listed below.

FIG. 1 is an elevation view of the wheel cylinder based auto adjuster that depicts the component details.

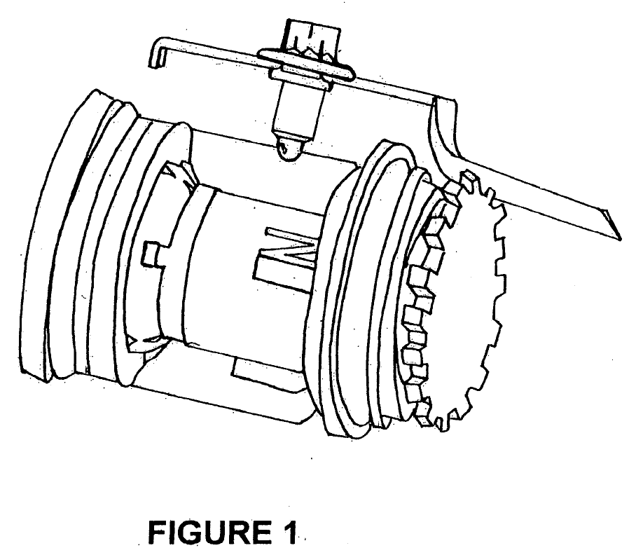

FIGS. 2A and 2B are vertical cross sections of the adjuster and adjusting screw that depicts the component details.

FIGS. 3A and 3B are elevation views of the wheel cylinder based auto adjuster that depicts the construction details.

FIG. 4A is a vertical cross section and 4B is an elevation view of the plunger that depicts the construction details.

FIG. 5A is a vertical cross section and 5B and 5C are elevation views of the cam screw that depicts the construction details.

FIG. 6A is a vertical cross section and 6B is an elevation view of the roller and adjusting screw that depicts the construction details.

FIG. 7A is a vertical cross section and 7B is an elevation view of the backlash that depicts the construction details.

FIGS. 8A and 8B are vertical cross sections of the auto adjuster that depicts the working principles of an onward stroke.

FIGS. 9A and 9B are vertical cross sections of the auto adjuster that depicts the working principles of a return stroke.

FIG. 10 is an elevation view of the auto adjuster that depicts the working principles of a manual adjustment.

### DETAILED DESCRIPTION OF THE INVENTION

The nature of the invention and the manner in which the invention is performed is clearly described in detail. The following description is presented to enable any person skilled in the art to make and use the invention, and is provided in the context of particular applications of the invention and their requirements. The present invention can be configured as follows:

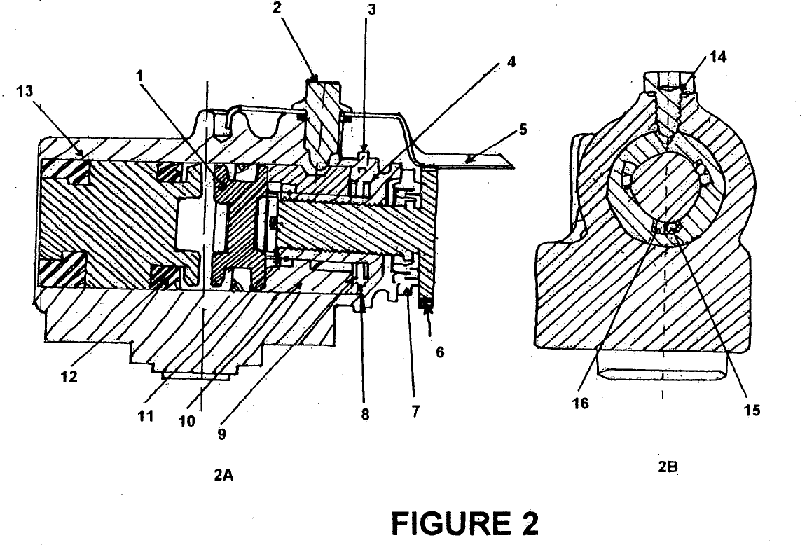

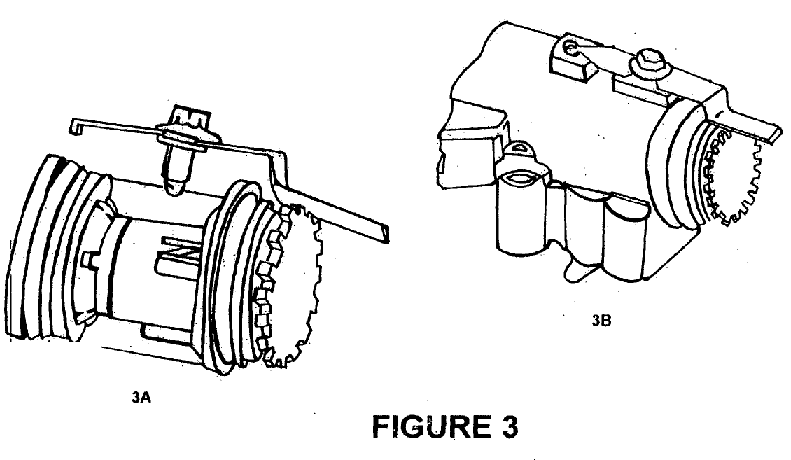

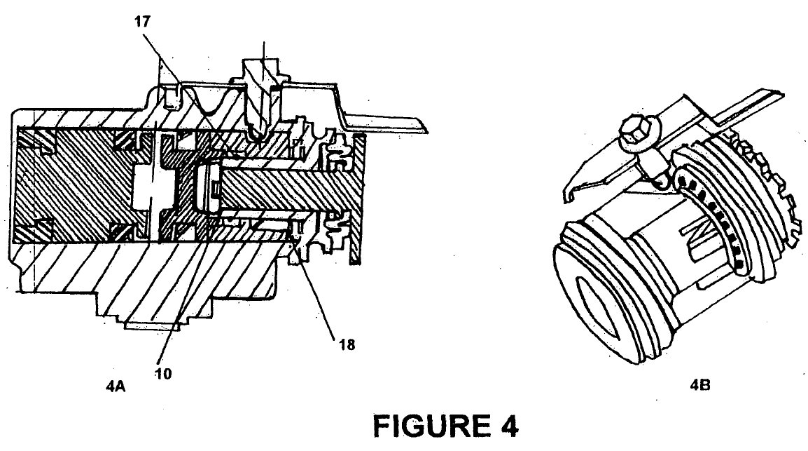

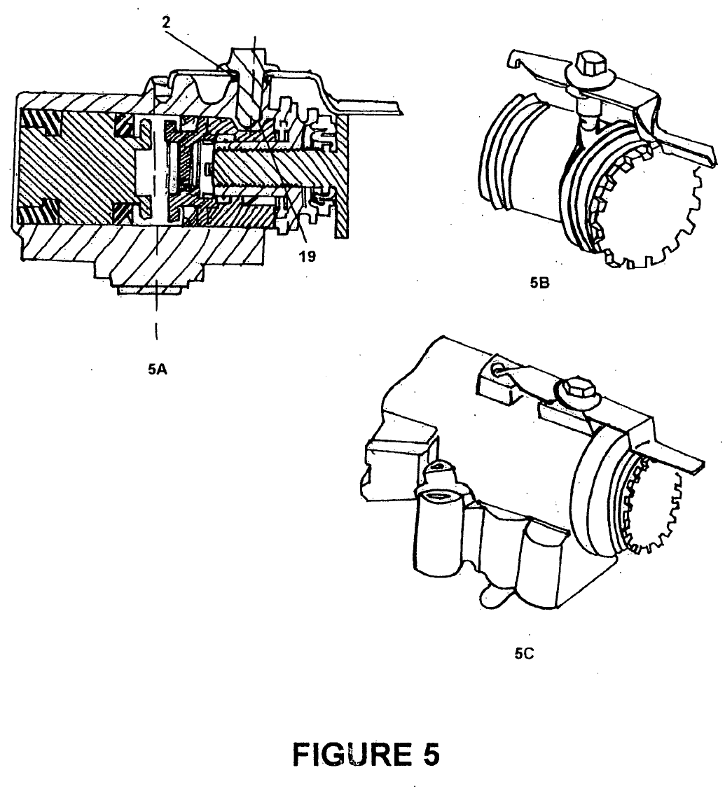

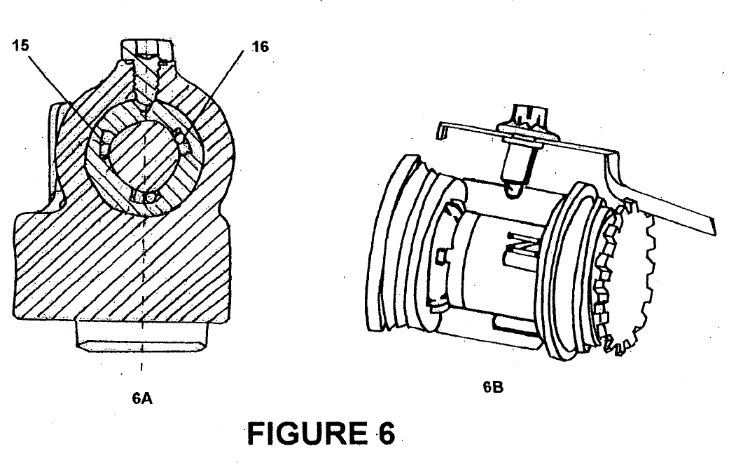

The accompanying pictures show the working of the auto adjustment mechanism. The first one is called the roller type and the second one is called the ratchet type. The roller type comprises of twelve parts as shown in the accompanying FIG. 2A. The conventional wheel cylinder plunger (10) (alternatively called piston as well) is modified to have a helical groove on its surface (as shown in the FIG. 3). This helical groove mates with a cam screw (2) that is mounted externally from wheel cylinder casting through threads. Sandwiched between the wheel cylinder plunger and the adjusting piston (4) are six rollers (15) of very high hardness that sit inside a wedge shaped slot (FIG. 2B). An accordion spring (16) is used to keep the roller in place as detailed in FIG. 6. These rollers act like bearings between the wheel cylinder plunger and the adjusting piston during forward motion of the wheel cylinder plunger. During reverse traverse of the wheel cylinder plunger, these rollers move to the smaller radial clearance portion of the wedge and thereby rigidly connect the adjusting piston with wheel cylinder plunger. Therefore, during the return stroke of the wheel cylinder plunger, both the wheel cylinder plunger and the adjusting piston move together as one piece. The adjusting screw (6) carries at its head an anti-rotation clip (11) into the slot of which the web gets positioned in an assembled brake. The anti-rotation clip is of spring steel material that provides positive non-rotary connection between the adjusting screw and the brake web, thereby communicating any forward movement of the adjusting screw to the brake web. The anti-rotation clip contains raised impressions in its structure that gets housed between two teeth on the outer diameter of the adjusting screw as shown in FIG. 4. Since the anti-rotation clip is of spring steel material, the adjusting screw can be rotated against the spring force of the clip in both clockwise and anticlockwise directions. Since the anti-rotation clip is held by the brake web, any rotation of the adjusting screw will force the adjusting screw to move either in a forward or in a reverse direction. This forward or reverse movement would help retract the brake (or collapse the brake), when necessary. The cam screw is fixed in the wheel cylinder machining and the cam end (19) projects into the helical groove of the plunger as shown in FIG. 5.

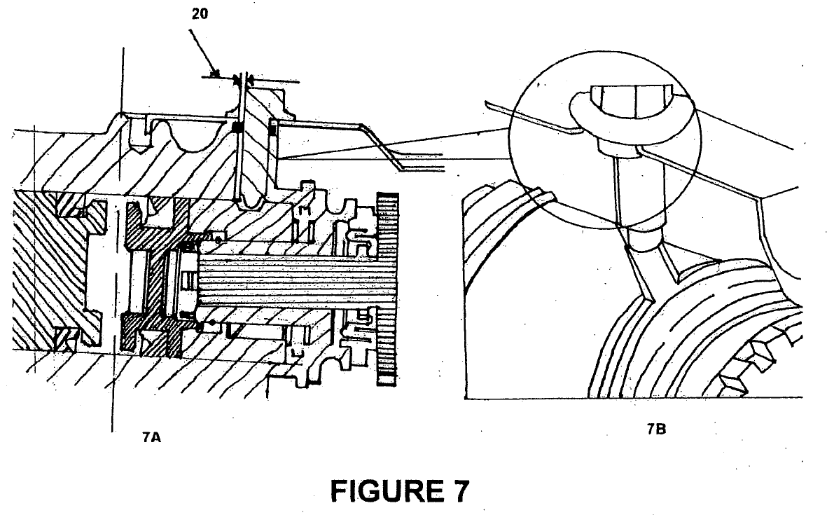

When the cam screw is seated inside the helical groove, there will be a gap between the wall of the helical groove and the cam screw as detailed in FIG. 7. This gap (or the distance) is called backlash (20). During normal operation of the brakes, when no adjustment is demanded by the system, the wheel cylinder plunger would axially move the set clearance between the lining and the drum. In order that the wheel cylinder piston moves this distance freely and without any problem, there must be sufficient gap between the cam screw and the wall of the helical groove. In addition, no adjustment must take place, when the system is having an elastic deformation due to brake application, temporary heat swell of the lining and the system, etc. The backlash contains not only the normal axial movement required for the wheel cylinder plunger, when no adjustment is demanded by the system, but also account for the above identified additional parameters.

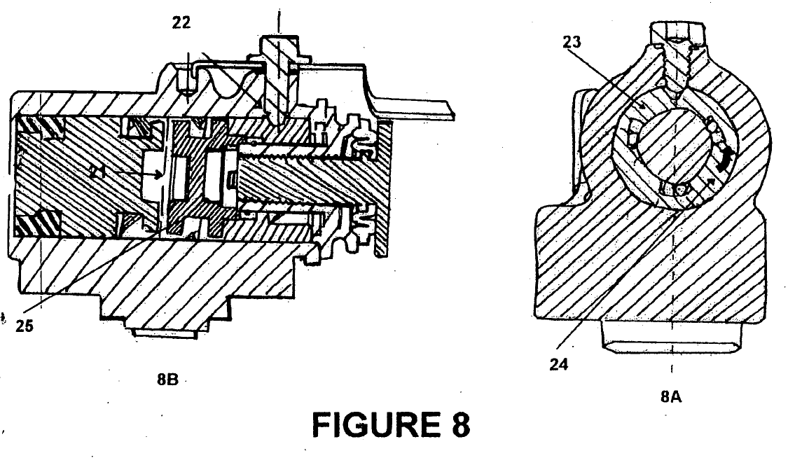

FIG. 8 describes the working principle of the onward stroke. On application of fluid pressure (21), the plunger moves and closes the backlash between the cam and the helical groove (22). It will only have linear motion till it closes the backlash. Once the back lash is close, the plunger hits the cam and rotates along the helical groove as shown in the direction of the arrow in the Figure (23). Thus is rotates and axially advances during forward stroke. This will happen only if the running clearance exceed backlash. In this direction of rotation the rollers will stay at the bigger end of the slot. Hence no frictional force will be generated between plunger and adjuster and thee two parts will not be connected together (24). The movement of the plunger makes the adjuster, screw and web to move forward to apply the brake. The axial thrust bearing prevents the rotation of adjuster along with the plunger due to the frictional force (25).

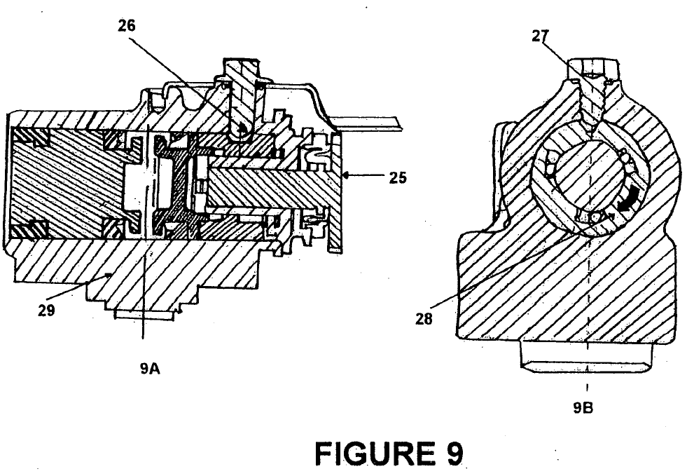

FIG. 9 describes the working principle of the return stroke. Shoe return spring forces the screw, adjuster and the plunger to move backwards (25). Plunger moves and hits the cam (26). Once the plunger hits the cam, it rotates along the helical groove as shown in the direction of the arrow (opposite to forward direction) (27). When the plunger rotates, the rollers are held in the smaller end of the slot. Thus it generates frictional force between the adjusted and the plunger. This frictional force connects the two parts together; hence the adjuster also starts rotating along the direction of the plunger. The accordion spring (16) pushes the rollers towards the smaller end to ensure positive lock (28). When the adjuster rotates the adjusting screw will also try to rotate. But it cannot since its rotation is prevented by the plate. So the adjuster screw will disengage and will axially advance to a distance corresponding to the wear (29).

Thus during normal brake applications, the wheel cylinder plunger moves forward an amount equivalent to the running clearance between the shoe and the drum. As the friction material wears off, this running clearance will keep increasing. When this clearance becomes more than the backlash designed, then cam screw will hit the other wall of the helical groove. This would force the wheel cylinder plunger to rotate, thereby gaining the additional axial movement required to effect the brake application. As the wheel cylinder plunger rotates axially (during forward motion), the entire train will move axially as well. There will be relative motion between wheel cylinder plunger and the adjusting piston (during forward motion), as the roller will act like bearing. During reverse traverse of the adjusting piston, the adjusting piston and the wheel cylinder plunger will lock with each other (due to the one way clutch) and move as one unit. During the reverse traverse, the wheel cylinder plunger will move axially equivalent to the backlash amount during the initial part and rotate during the later part. During this later part, as the wheel cylinder piston and the adjusting piston move together and the adjusting screw is held by the web through the slot in the anti-rotation clip, the adjusting screw must unscrew to compensate for the extra travel of the wheel cylinder plunger (this extra travel is equal to the wear of the friction material).

In the second design (ratchet type), the cam screw is replaced by a drive ring which converts the linear travel into rotary motion. The drive ring has multiple helical grooves and is attached to the wheel cylinder body at its mouth. The conventional wheel cylinder plunger is provided with a collar which has corresponding male helical lands. This mates with the female grooves of the drive ring at assembled condition. The gap between the helical groove of the drive ring and those of the plunger is just sufficient for assembly. Thus, whenever the wheel cylinder plunger moves, it has linear and rotary motion. The plunger houses an insert called as Plunger insert as a sliding fit (17) as detailed in FIG. 4. The plunger axially butts against the thrust bearing (18). The flats provided at the sliding area ensure positive rotation of the plunger insert whenever the plunger rotates. A wave spring assembled at the rear of the plunger insert keeping it in position along with a circlip. The plunger insert has two very small teeth located radially 180 degrees apart on the outer face.

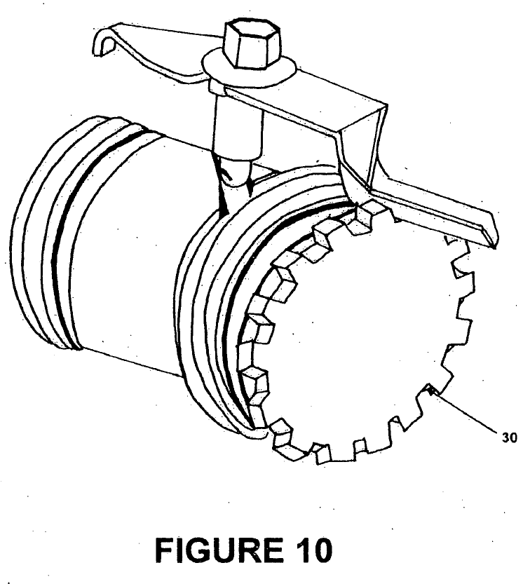

The adjuster wheel consists of 2 parts, the adjuster and a lock ring. The lock ring has ratchet type teeth on one of its faces in a circular pattern. The periphery of the lock ring has teeth similar to a saw tooth profile. The adjuster and the lock ring are attached together to form the adjuster wheel assembly. When the adjuster wheel is assembled with the plunger the ratchet teeth locks with the two teeth provided in the plunger insert. The lock between the lock ring and plunger insert is in such a manner as to allow free rotation of the plunger without making the adjuster rotate during forward traverse and lock them together during reverse traverse. A Clip that is fastened to the wheel cylinder body has one end sitting on the periphery teeth of the lock ring. This clip allows the adjuster to rotate only during reverse traverse. The adjusting screw has an external land over which the web seats itself. In this design the positive lock between the screw and the web is provided by a swivel type clip that is pivoted onto the shoe. If the need for manual adjustment arises, this clip is swiveled out so as to free the screw for rotation as seen in FIG. 10. The adjusting screw has teeth on its outer diameter for rotation during manual override.

During normal brake applications, the wheel cylinder plunger moves forward an amount equivalent to the running clearance between the shoe and the drum. When this happens the plunger rotates along with the plunger insert. The backlash in this case is determined by the amount of travel required by the plunger so as to have the plunger insert slip over the next tooth of the lock ring. As the running clearance is to the set value, no adjustment takes place during normal brake application. As the friction material wears off, this running clearance will keep increasing, hence allowing the plunger insert to rotate more in the forward traverse. This makes the teeth of the plunger insert to slip over the subsequent teeth in the lock ring during the forward stroke. Thereafter during the return stroke, plunger and the plunger insert rotates the adjuster wheel. As the screw is locked with the shoe by means of the swiveling clip, the rotation of the adjuster wheel unwinds the screw (FIG. 9). This compensates for the extra travel of the wheel cylinder plunger caused by the wear of the friction material.

To simplify the description of the exemplary embodiments, the invention is frequently described as pertaining to a system of an auto adjuster used in vehicles. It will be appreciated, however, that many applications of the present invention could be formulated.

### DISCLOSURE OF INVENTION

Various modifications to the disclosed embodiments will be readily apparent to those skilled in the art and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

We claim:

1. Wheel cylinder based auto adjuster incorporated within the wheel cylinder housing, comprising a (13) housing, (12) lip seal, (10) plunger, (4) adjuster, (6) adjusting screws, (3) dust cover, (2) a cam screw, (9) copper washer, (8) thrust bearing and (7) excluder assembly characterized in that the said adjusting screw and adjuster being connected by means of (15) threaded joint roller.

2. Wheel cylinder based auto adjuster incorporated within the wheel cylinder housing as claimed in claim 1 wherein said adjuster axially butts against the said plunger,

3. Wheel cylinder based auto adjuster incorporated within the wheel cylinder housing as claimed in claim 1 wherein a sliding fete between the said plunger diameter and said adjuster outer diameter is positioned such that that the said adjuster slides inside the said plunger.

4. Wheel cylinder based auto adjuster incorporated within the wheel cylinder housing as claimed in claim 1 wherein a needle roller thrust bearing is assembled between the said plunger and said adjuster.
